(19) United States
(12) Patent Application Publication
(10) Pub. No.: US 2022/0056207 A1
(43) Pub. Date: Feb. 24, 2022

(54) METHOD FOR PRODUCING A POLYESTER-POLYETHER POLYOL BLOCK COPOLYMER

(71) Applicant: Covestro Intellectual Property GmbH & Co. KG, Leverkusen (DE)

(72) Inventors: Markus Meuresch, Köln (DE); Christoph Guertler, Köln (DE); Aurel Wolf, Wülfrath (DE); Martin Machat, Köln (DE)

(21) Appl. No.: 17/312,470

(22) PCT Filed: Dec. 16, 2019
(86) PCT No.: PCT/EP2019/085305

§ 371 Date: Jun. 10, 2021

(30) Foreign Application Priority Data
Dec. 21, 2018 (EP) 18215182.9

(51) Int. Cl. C08G 65/26; C08L 75/08; C08G 63/66

(52) U.S. Cl. CPC C08G 65/2615; C08G 63/66; C08L 75/08; C08G 65/2663

(57) ABSTRACT

The present invention relates to a process for preparing a polyester-polyether polyol block copolymer by reaction of an H-functional starter substance with lactone in the presence of a catalyst to afford a polyester followed by reaction of the polyester from step i) with alkylene oxides in the presence of a catalyst (B), wherein the lactone is a 4-membered lactone. The invention further relates to the polyester-polyether polyol block copolymer obtainable by the present process.

The present invention relates to a process for preparing a polyester-polyether polyol block copolymer by reaction of an H-functional starter substance with lactone in the presence of a catalyst to afford a polyester followed by reaction of the polyester from step i) with alkylene oxides in the presence of a catalyst (B), wherein the lactone is a 4-membered lactone. The invention further relates to the polyester-polyether polyol block copolymer obtainable by the present process.

WO 2011/000560 A1 discloses a process for preparing polyether ester polyols having primary hydroxyl end groups, comprising the steps of reacting a starter compound comprising active hydrogen atoms with an epoxide under double metal cyanide catalysis, reacting the obtained product with a cyclic carboxylic anhydride and reacting this obtained product with ethylene oxide in the presence of a catalyst comprising at least one nitrogen atom per molecule with the exception of acyclic, identically substituted tertiary amines. The resulting polyether ester polyols of this multistage process have a primary hydroxyl proportion of not more than 76%.

WO2008/104723 A1 discloses a process for preparing a polylactone or polylactam, wherein the lactone or lactam is reacted with an H-functional starter substance in the presence of a non-chlorinated aromatic solvent and a sulfonic acid on a microliter scale. Employed here as the H-functional starter substance are low molecular weight monofunctional or polyfunctional alcohols or thiols, wherein the working examples disclose (monofunctional) n-pentanol with ε-caprolactone or 3-valerolactone in the presence of large amounts of trifluoromethanesulfonic acid of 2.5 mol % or more.

Couffin et al. Poly. Chem 2014, 5, 161 discloses a selective O-acyl opening of β-butyrolactone with H-functional starter substances such as for example n-pentanol, 1,4-butanediol and polyethylene glycol in deuterated benzene and in the presence of trifluoromethanesulfonic acid in a batch mode. The reactions are performed on a microliter scale and large amounts of the acid catalyst of 2.5 mol % or more based on the amount of employed lactone are used.

GB1201909 likewise discloses a process for preparing polyester by reaction of a lactone with an H-functional starter compound in the presence of an organic carboxylic acid or sulfonic acid having a PKa at 25° C. of less than 2.0. All reaction components such as short-chain alcohols and epsilon-caprolactone or mixtures of isomeric methyl-epsilon-caprolactone were initially charged in large amounts of trichloro- or trifluoroacetic acid catalyst and reacted for at least 20 h in a batch process to afford solids or liquid products having a broad molar mass distribution.

U.S. Pat. No. 5,032,671 discloses a process for preparing polymeric lactones by reaction of an H-functional starter substance and lactones in the presence of a double metal cyanide (DMC) catalyst. The working examples disclose the reaction of polyether polyols with ε-caprolactone, δ-valerolactone or β-propiolactone to afford polyether-polyester polyol block copolymers, wherein these reactions are performed in the presence of large amounts of 980 ppm to 1000 ppm of the cobalt-containing DMC catalyst and in the presence of organic solvents, wherein the resulting products have a broad molar mass distribution of 1.32 to 1.72. For the reaction of the polyether polyol based on a trifunctional triol starter with β-propiolactone to afford the polyester-polyether polyol block copolymer only the formation of the resulting product with a molar mass of 10 000 g/mol is postulated. This process further requires a workup step wherein the products are filtered through diatomaceous earth and the solvent is subsequently removed.

Starting from the prior art it was an object of the present invention to improve and to simplify the preparation of polyesters in respect of the formation of a defined, reproducible reaction product with incorporation of all reaction components, wherein the resulting polyester products exhibit not only hydroxyl end groups but also an improved thermal stability in order that they may be directly employed in the reaction with isocyanates in the exothermic polyurethane reaction.

It has surprisingly been found that the object of the invention is solved by a process for preparing a polyester-polyether polyol block copolymer comprising the steps of:

i) reacting an H-functional starter substance with lactone to afford a polyester

ii) reacting the polyester from step i) with alkylene oxides in the presence of a catalyst (B).

The polyester-polyether polyol block copolymer according to the invention is to be understood as meaning a block copolymer consisting of an inner block (A), preferably polyester block (A), formed in the 1st process step and an outer block (B), preferably polyether polyol block (B), formed in step ii) chemically bonded thereto. In the case of an inner polyester block (A) having two terminal carboxyl groups step ii) comprises reacting both carboxyl groups with alkylene oxides to form two outer terminal polyether polyol blocks (B), thus forming a (B)-(A)-(B) structure.

In the case of a polyester block (A) having two terminal hydroxy groups step ii) comprises reacting both hydroxy groups with alkylene oxides to form two outer terminal polyether polyol blocks (B), thus forming a (B)-(A)-(B) structure.

The inner block (A) may also itself have a block copolymer structure for example through reaction of hydroxy- and/or carboxy-terminated polyesters, polycarbonates, polyether carbonates, polyether ester carbonate polyols and polyethers (block A′) with lactones (polyester A″) to form an (A″)-(A′)-(A″) structure.

H-Functional Starter Substance

In one embodiment of the process according to the invention the H-functional starter substance comprises an H-functional starter compound having one or more free carboxyl groups and/or functional starter compound having one or more free hydroxyl groups, preferably an H-functional starter compound having one or more free carboxyl groups.

In one embodiment of the process according to the invention an H-functional compound is used, wherein the H-functional compound comprises one or more hydroxyl groups, preferably 1 to 8 and particularly preferably 2 to 6.

Employable H-functional compounds having a hydroxyl group include C1 to C20 alcohols such as for example methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, dodecanol, tetradecanol, hexadecanol and octadecanol.

Suitable H-functional compounds having a plurality of hydroxyl groups include polyhydric C1 to C20 alcohols such as for example dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentantane-1,5-diol, methylpentanediols (for example 3-methylpentane-1,5-diol), hexane-1,6-diol, octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxy-functionalized fats and oils, especially castor oil), and also all products of modification of these aforementioned alcohols having different amounts of ε-caprolactone.

The H-functional starter substances having a plurality of hydroxyl groups may also be selected from the class of polyether polyols, especially those having a molecular weight Mn in the range from 100 to 4000 g/mol. Preference is given to polyether polyols constructed from repeating ethylene oxide and propylene oxide units, preferably having a proportion of propylene oxide units of from 35% to 100%, particularly preferably having a proportion of propylene oxide units of from 50% to 100%. These may be random copolymers, gradient copolymers, alternating copolymers or block copolymers of ethylene oxide and propylene oxide. Suitable polyether polyols constructed from repeating propylene oxide and/or ethylene oxide units are for example the Desmophen®-, Acclaim®-, Arcol®-, Baycoll®-, Bayfill®-, Bayflex®-, Baygal®-, PET®- and polyether polyols from Covestro AG (e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are for example the Pluriol® E products from BASF SE, suitable homopolypropylene oxides are for example the Pluriol® P products from BASF SE, suitable mixed copolymers of ethylene oxide and propylene oxide are for example the Pluronic® PE or Pluriol® RPE products from BASF SE.

The H-functional starter substances having a plurality of hydroxyl groups may also be selected from the class of polyester polyols, especially those having a molecular weight Mn in the range from 200 to 4500 g/mol. Polyester polyols used may be at least difunctional polyesters. Polyester polyols preferably consist of alternating acid and alcohol units. Examples of acid components that may be used include succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride, or mixtures of the recited acids and/or anhydrides. Alcohol components employed include for example ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane, diethylene glycol, dipropylene glycol, trimethylolpropane, glycerol, pentaerythritol or mixtures of the stated alcohols. Using dihydric or polyhydric polyether polyols as the alcohol component affords polyesterether polyols which may likewise be used as starter substances for preparation of the polyethercarbonate polyols. It is preferable to use polyether polyols having Mₙ=150 to 2000 g/mol for preparation of the polyesterether polyols.

H-functional starter substances having a plurality of hydroxyl groups that may be employed further include polycarbonate diols, in particular those having a molecular weight Mn in the range from 150 to 4500 g/mol, preferably 500 to 2500 g/mol, prepared, for example, by reaction of phosgene, dimethyl carbonate, diethyl carbonate or diphenyl carbonate and difunctional alcohols or polyester polyols or polyether polyols. Examples for polycarbonates can be found, for example, in EP-A 1359177. Polycarbonate diols that may be used include for example the Desmophen® C line from Covestro AG, for example Desmophen® C 1100 or Desmophen® C 2200.

In a further embodiment of the invention polyether carbonate polyols and/or polyether ester carbonate polyols may be used as H-functional starter substances having a plurality of hydroxyl groups. Polyether ester carbonate polyols in particular may be employed. To this end, these polyether ester carbonate polyols used as H-functional starter substances may be prepared beforehand in a separate reaction step.

In a preferred embodiment of the process according to the invention an H-functional compound is used, wherein the H-functional compound comprises one or more carboxyl groups, preferably 1 to 8 and particularly preferably 2 to 6.

In one embodiment of the process according to the invention the H-functional compound having one or more carboxyl groups has no free primary and/or secondary hydroxyl groups.

In a preferred embodiment of the process according to the invention the H-functional starter substance having one or more free carboxyl groups is one or more compounds and is selected from the group consisting of monobasic carboxylic acids, polybasic carboxylic acids, carboxyl-terminated polyesters, carboxyl-terminated polycarbonates, carboxyl-terminated polyether carbonates, carboxyl-terminated polyether ester carbonate polyols and carboxyl-terminated polyethers.

Suitable monobasic carboxylic acids include monobasic C1 to C20 carboxylic acids such as for example methanoic acid, ethanoic acid, propanoic acid, butanoic acid, pentanoic acid, hexanoic acid, heptanoic acid, octanoic acid, decanoic acid, dodecanoic acid, tetradecanoic acid, hexadecanoic acid, octadecanoic acid, lactic acid, fluoroacetic acid, chloroacetic acid, bromoacetic acid, iodoacetic acid, difluoroacetic acid, trifluoroacetic acid, dichloroacetic acid, trichloroacetic acid, oleic acid, salicylic acid, benzoic acid, acrylic acid and methacrylic acid.

Suitable polybasic carboxylic acids include polybasic C1 to C20 carboxylic acids such as for example oxalic acid, malonic acid, succinic acid, glutaric acid, adipic acid, pimelic acid, suberic acid, azelaic acid, sebacic acid, citric acid, trimesic acid, fumaric acid, maleic acid, 1,10-decanedicarboxylic acid, 1,12-dodecanedicarboxylic acid, phthalic acid, isophthalic acid, terephthalic acid, pyromellitic acid and trimellitic acid.

The H-functional starter substances may also be selected from the class of carboxyl-terminated polyesters, especially those having a molecular weight Mn in the range from 50 to 4500 g/mol. Polyesters having a functionality of at least two can be used as polyesters. Polyesters preferably consist of alternating acid and alcohol units. Employable acid components include for example succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the recited acids and/or anhydrides. Alcohol components employed include for example ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane, diethylene glycol, dipropylene glycol, trimethylolpropane, glycerol, pentaerythritol or mixtures of the stated alcohols. The resulting polyesters have terminal carboxyl groups.

It is preferable to obtain carboxyl-terminated polycarbonates for example by reaction of polycarbonate polyols, preferably polycarbonate diols, with stoichiometric addition or stoichiometric excess, preferably stoichiometric excess, of polybasic carboxylic acids and/or cyclic anhydrides.

The polycarbonate diols especially have a molecular weight Mn in the range from 1000 to 4500 g/mol, preferably 1500 to 2500 g/mol, wherein the polycarbonate diols are prepared for example by reaction of phosgene, dimethyl carbonate, diethyl carbonate or diphenyl carbonate and difunctional alcohols or polyester polyols or polyether polyols. Examples for polycarbonates can be found, for example, in EP-A 1359177. Polycarbonate diols that may be used include for example the Desmophen® C line from Covestro AG, for example Desmophen® C 1100 or Desmophen® C 2200. Cyclic anhydrides include for example succinic anhydride, methylsuccinic anhydride, maleic anhydride, phthalic anhydride, tetrahydrophthalic anhydride and hexahydrophthalic anhydride.

It is preferable to obtain carboxyl-terminatedpolyether carbonates and/or polyether ester carbonates for example by reaction of polyether carbonate polyols and/or polyether ester carbonate polyols with stoichiometric addition or stoichiometric excess, preferably stoichiometric excess, of polybasic carboxylic acids and/or cyclic anhydrides. Polyether carbonate polyols (for example Cardyon® polyols from Covestro), polycarbonate polyols (for example Converge® polyols from Novomer/Saudi Aramco, NEOSPOL polyols from Repsol etc.) and/or polyether ester carbonate polyols are employed. In particular, polyether carbonate polyols, polycarbonate polyols and/or polyether ester carbonate polyols may be obtained by reaction of alkylene oxides, preferably ethylene oxide, propylene oxide or mixtures thereof, optionally further comonomers, with CO2 in the presence of a further H-functional starter compound and using catalysts. These catalysts include double metal cyanide catalysts (DMC catalysts) and/or metal complex catalysts for example based on the metals zinc and/or cobalt, for example zinc glutarate catalysts (described for example in M. H. Chisholm et al., Macromolecules 2002, 35, 6494), so-called zinc diiminate catalysts (described for example in S. D. Allen, J. Am. Chem. Soc. 2002, 124, 14284) and so-called cobalt salen catalysts (described for example in U.S. Pat. No. 7,304,172 B2, US 2012/0165549 A1) and/or manganese salen complexes. An overview of the known catalysts for the copolymerization of alkylene oxides and CO2 may be found for example in Chemical Communications 47 (2011) 141-163. The use of different catalyst systems, reaction conditions and/or reaction sequences results in the formation of random, alternating, block-type or gradient-type polyether carbonate polyols, polycarbonate polyols and/or polyether ester carbonate polyols. To this end, these polyether carbonate polyols, polycarbonate polyols and/or polyether ester carbonate polyols used as H-functional starter compounds may be prepared beforehand in a separate reaction step. Cyclic anhydrides include for example succinic anhydride, methylsuccinic anhydride, maleic anhydride, phthalic anhydride, tetrahydrophthalic anhydride and hexahydrophthalic anhydride.

It is preferable to obtain carboxyl-terminatedpolyethers for example by reaction of polyether polyols with stoichiometric addition or stoichiometric excess, preferably stoichiometric excess, of polybasic carboxylic acids and/or cyclic anhydrides. The polyether polyols constructed from repeating ethylene oxide and propylene oxide units, preferably having a proportion of propylene oxide units of 50% to 100%, particularly preferably having a proportion of propylene oxide units of 80% to 100%. These may be random copolymers, gradient copolymers, alternating copolymers or block copolymers of ethylene oxide and propylene oxide. Suitable polyether polyols constructed from repeating propylene oxide and/or ethylene oxide units are for example the Desmophen®-, Acclaim®-, Arcol®-, Baycoll®-, Bayfill®-, Bayflex®-, Baygal®-, PET®- and polyether polyols from Covestro AG (e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are for example the Pluriol® E products from BASF SE, suitable homopolypropylene oxides are for example the Pluriol® P products from BASF SE, suitable mixed copolymers of ethylene oxide and propylene oxide are for example the Pluronic® PE or Pluriol® RPE products from BASF SE. Cyclic anhydrides include for example maleic anhydride, succinic anhydride, methylsuccinic anhydride, phthalic anhydride, tetrahydrophthalic anhydride and hexahydrophthalic anhydride.

In one embodiment of the process according to the invention the H-functional starter substance having one or more free carboxyl groups is one or more compounds and is selected from the group consisting of methanoic acid, ethanoic acid, propanoic acid, butanoic acid, pentanoic acid, hexanoic acid, heptanoic acid, octanoic acid, decanoic acid, dodecanoic acid, tetradecanoic acid, hexadecanoic acid, octadecanoic acid, lactic acid, fluoroacetic acid, chloroacetic acid, bromoacetic acid, iodoacetic acid, difluoroacetic acid, trifluoroacetic acid, dichloroacetic acid, trichloroacetic acid, oleic acid, salicylic acid, benzoic acid, oxalic acid, malonic acid, succinic acid, glutaric acid, adipic acid, pimelic acid, suberic acid, azelaic acid, sebacic acid, citric acid, trimesic acid, fumaric acid, maleic acid, 1,10-decanedicarboxylic acid, 1,12-dodecanedicarboxylic acid, phthalic acid, isophthalic acid, terephthalic acid, pyromellitic acid and trimellitic acid, acrylic acid and methacrylic acid.

According to the technical common general knowledge in organic chemistry lactones are to be understood as meaning heterocyclic compounds, wherein lactones are formed by intramolecular esterification, i.e. reaction of a hydroxy functionality with a carboxyl functionality of a hydroxycarboxylic acid. They are therefore cyclic esters having a ring oxygen.

In one embodiment of the process according to the invention the 4-membered ring lactone is one or more compounds selected from the group consisting of propiolactone, β-butyrolactone, diketene, preferably propiolactone and β-butyrolactone.

In one embodiment of the process according to the invention step i) is carried out in the presence of the catalyst (A).

In a preferred embodiment of the process according to the invention the catalyst (A) used in step i) is an amine (A), a double metal cyanide (DMC) catalyst (A) or a Brønsted-acidic catalyst (A), preferably a double metal cyanide (DMC) catalyst (A).

In one embodiment of the process according to the invention the catalyst (A) is an amine (A), wherein the tertiary amine (A) is at least one compound selected from at least one group consisting of:

(A) amines of the general formula (21:

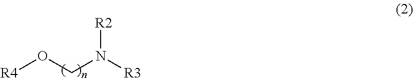

where:
R2 and R3 are independently hydrogen, alkyl or aryl; or
R2 and R3 together with the nitrogen atom bearing them form an aliphatic, unsaturated or aromatic heterocycle;
n is an integer from 1 to 10;
R4 is hydrogen, alkyl or aryl; or
R4 is —(CH2)x-N(R41)(R42) where:
R41 and R42 are independently hydrogen, alkyl or aryl; or
R41 and R42 together with the nitrogen atom bearing them form an aliphatic, unsaturated or aromatic heterocycle;
x is an integer from 1 to 10;

(B) amines of the general formula (3):

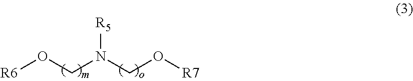

where:
R5 is hydrogen, alkyl or aryl;
R6 and R7 are independently hydrogen, alkyl or aryl;
m and o are independently an integer from 1 to 10;

and/or:

(C) diazabicyclo[2.2.2]octane, diazabicyclo[5.4.0]undec-7-ene, dialkylbenzylamine, dimethylpiperazine, 2,2′-dimorpholinyl diethyl ether and/or pyridine.

In one embodiment of the process according to the invention the catalyst (A) is a double metal cyanide (DMC) catalyst (A).

The DMC catalysts preferably employable in the process according to the invention contain double metal cyanide compounds which are the reaction products of water-soluble metal salts and water-soluble metal cyanide salts.

Double metal cyanide (DMC) catalysts for use in the homopolymerization of alkylene oxides are known in principle from the prior art (see, for example, U.S. Pat. Nos. 3,404,109, 3,829,505, 3,941,849 and U.S. Pat. No. 5,158,922). DMC catalysts described, for example, in U.S. Pat. No. 5,470,813, EP-A 700 949, EP-A 743 093, EP-A 761 708, WO 97/40086, WO 98/16310 and WO 00/47649 have a very high activity and enable the preparation of polyoxyalkylene polyols at very low catalyst concentrations. A typical example is that of the highly active DMC catalysts described in EP-A 700 949 which, as well as a double metal cyanide compound (e.g. zinc hexacyanocobaltate(III)) and an organic complex ligand (e.g. tert-butanol), also contain a polyether having a number-average molecular weight greater than 500 g/mol.

The DMC catalysts which can be used in accordance with the invention are preferably obtained by

(1.) reacting an aqueous solution of a metal salt with the aqueous solution of a metal cyanide salt in the presence of one or more organic complex ligands, e.g. an ether or alcohol, in a first step,

(2.) removing the solid from the suspension obtained from (1.) by known techniques (such as centrifugation or filtration) in a second step,

(3.) optionally washing the isolated solid with an aqueous solution of an organic complex ligand (for example by resuspending and subsequent reisolating by filtration or centrifugation) in a third step,

(4.) and subsequently drying the solid obtained at temperatures of in general 20-120° C. and at pressures of in general 0.1 mbar to atmospheric pressure (1013 mbar), optionally after pulverizing, wherein in the first step or immediately after the precipitation of the double metal cyanide compound (second step) one or more organic complex ligands, preferably in excess (based on the double metal cyanide compound), and optionally further complex-forming components are added.

The double metal cyanide compounds present in the DMC catalysts that can be used in accordance with the invention are the reaction products of water-soluble metal salts and water-soluble metal cyanide salts.

By way of example, an aqueous zinc chloride solution (preferably in excess relative to the metal cyanide salt) and potassium hexacyanocobaltate are mixed and then dimethoxyethane (glyme) or tert-butanol (preferably in excess, relative to zinc hexacyanocobaltate) is added to the resulting suspension.

Metal salts suitable for preparing the double metal cyanide compounds preferably have a composition according to the general formula (I),

M(X)n (I),

where

M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

n is 1 if X=sulfate, carbonate or oxalate and

n is 2 if X=halide, hydroxide, carboxylate, cyanate, thiocyanate, isocyanate, isothiocyanate or nitrate,

or suitable metal salts preferably have a composition according to the general formula (II)

Mr(X)3 (II),

where

M is selected from the metal cations Fe³⁺, Al³⁺, Co³⁺ and Cr³⁺,

X comprises one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

r is 2 if X=sulfate, carbonate or oxalate and

r is 1 if X=halide, hydroxide, carboxylate, cyanate, thiocyanate, isocyanate, isothiocyanate or nitrate,

or suitable metal salts preferably have a composition according to the general formula (III)

M(X)s (III),

where

M is selected from the metal cations Mo⁴⁺, V⁶⁺ and W⁴⁺,

X comprises one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 if X=sulfate, carbonate or oxalate and

s is 4 if X=halide, hydroxide, carboxylate, cyanate, thiocyanate, isocyanate, isothiocyanate or nitrate,

or suitable metal salts preferably have a composition according to the general formula (IV)

M(X)t (IV),

where

M is selected from the metal cations Mo⁶⁺ and W⁶⁺,

X comprises one or more (i.e. different) anions, preferably anions selected from the group of the halides (i.e. fluoride, chloride, bromide, iodide), hydroxide, sulfate, carbonate, cyanate, thiocyanate, isocyanate, isothiocyanate, carboxylate, oxalate and nitrate;

t is 3 if X=sulfate, carbonate or oxalate and

t is 6 if X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparing the double metal cyanide compounds preferably have a composition according to the general formula (V)

(Y)aM′(CN)b(A)c (V),

where

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate, and

a, b and c are integers, wherein the values for a, b and c are selected so as to ensure the electroneutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds included in the DMC catalysts which can be used in accordance with the invention are compounds having compositions according to the general formula (VI)

Mx[M′x,(CN)y]z (VI),

in which M is defined as in the formulae (I) to (IV) and

M′ is as defined in formula (V), and

x, x′, y and z are integers and are selected such as to ensure the electroneutrality of the double metal cyanide compound.

Preferably,

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds (VI) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). With particular preference it is possible to use zinc hexacyanocobaltate(III).

The organic complex ligands which can be added in the preparation of the DMC catalysts are disclosed in, for example, U.S. Pat. No. 5,158,922 (see, in particular, column 6, lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). For example, organic complex ligands used are water-soluble organic compounds having heteroatoms, such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds which include both aliphatic or cycloaliphatic ether groups and aliphatic hydroxyl groups (such as ethylene glycol mono-tert-butyl ether, diethylene glycol mono-tert-butyl ether, tripropylene glycol monomethyl ether and 3-methyl-3-oxetanemethanol, for example). Extremely preferred organic complex ligands are selected from one or more compounds of the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol.

In the preparation of the DMC catalysts that can be used in accordance with the invention, there is optional use of one or more complex-forming components from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid copolymers and maleic anhydride copolymers, hydroxyethylcellulose and polyacetals, or of the glycidyl ethers, glycosides, carboxylic esters of polyhydric alcohols, bile acids or salts, esters or amides thereof, cyclodextrins, phosphorus compounds, α,β-unsaturated carboxylic esters, or ionic surface-active or interface-active compounds.

In the preparation of the DMC catalysts that can be used in accordance with the invention, preference is given to using the aqueous solutions of the metal salt (e.g. zinc chloride) in the first step in a stoichiometric excess (at least 50 mol %) relative to the metal cyanide salt. This corresponds to at least a molar ratio of metal salt to metal cyanide salt of 2.25:1.00. The metal cyanide salt (e.g. potassium hexacyanocobaltate) is reacted in the presence of the organic complex ligand (e.g. tert-butanol), and a suspension is formed which comprises the double metal cyanide compound (e.g. zinc hexacyanocobaltate), water, excess metal salt, and the organic complex ligand.

The organic complex ligand may be present in the aqueous solution of the metal salt and/or of the metal cyanide salt or it is added directly to the suspension obtained after precipitation of the double metal cyanide compound. It has proven advantageous to mix the metal salt and metal cyanide salt aqueous solutions and the organic complex ligand by stirring vigorously. Optionally, the suspension formed in the first step is subsequently treated with a further complex-forming component. This complex-forming component is preferably used in a mixture with water and organic complex ligand.

A preferred process for performing the first step (i.e. the preparation of the suspension) is effected using a mixing nozzle, particularly preferably using a jet disperser, as described, for example, in WO-A 01/39883.

In the second step, the solid (i.e. the precursor of the catalyst) can be isolated from the suspension by known techniques, such as centrifugation or filtration.

In a preferred variant, the isolated solid is subsequently washed in a third process step with an aqueous solution of the organic complex ligand (for example by resuspension and subsequent reisolation by filtration or centrifugation). In this way, for example, water-soluble by-products, such as potassium chloride, can be removed from the catalyst that can be used in accordance with the invention. The amount of the organic complex ligand in the aqueous washing solution is preferably between 40 and 80% by weight, based on the total solution.

Optionally, in the third step, the aqueous washing solution is admixed with a further complex-forming component, preferably in the range between 0.5% and 5% by weight, based on the overall solution.

It is also advantageous to wash the isolated solid more than once. It is preferable when in a first wash step this solid is washed with an aqueous solution of the organic complex ligand (for example by resuspension and subsequent reisolation by filtration or centrifugation), in order in this way to remove, for example, water-soluble by-products, such as potassium chloride, from the catalyst employable according to the invention. It is particularly preferable when the amount of the organic complex ligand in the aqueous washing solution is between 40% and 80% by weight based on the overall solution for the first wash step. In the further wash steps either the first wash step is repeated once or several times, preferably from one to three times, or, preferably, a nonaqueous solution, such as a mixture or solution of organic complex ligand and further complex-forming component (preferably in the range between 0.5% and 5% by weight, based on the total amount of the washing solution of the step), is used as the washing solution, and the solid is washed with it once or more than once, preferably from one to three times.

The isolated and optionally washed solid can then be dried, optionally after pulverization, at temperatures of 20-100° C. and at pressures of 0.1 mbar to atmospheric pressure (1013 mbar).

A preferred process for isolating the DMC catalysts employable in accordance with the invention from the suspension by filtration, filtercake washing and drying is described in WO-A 01/80994.

In a preferred embodiment of the process according to the invention the double metal cyanide catalyst (A) comprises an organic complex ligand, wherein the organic complex ligand is one or more compounds and is selected from the group consisting of tert-butanol, 2-methyl-3-buten-2-ol, 2-methyl-3-butyn-2-ol, ethylene glycol mono-tert-butyl ether and 3-methyl-3-oxetanemethanol.

In one embodiment of the process according to the invention the double metal cyanide (DMC) catalyst is employed in an amount of 20 ppm to 5000 ppm, preferably 50 ppm to 4000 ppm, based on the polyester formed.

Brønsted-Acidic Catalyst (A)

In a further embodiment of the process according to the invention the catalyst (A) is a Brønsted acid (Brønsted-acidic catalyst (A)).

In line with the customary definition in the art Brønsted acids are to be understood as meaning substances capable of transferring protons to a second reaction partner, the so-called Brønsted base, typically in an aqueous medium at 25° C. In the context of the present invention the term “Brønsted-acidic catalyst” is to be understood as meaning a non-polymeric compound, wherein the Brønsted-acidic catalyst has a calculated molar mass of <1200 g/mol, preferably of <1000 g/mol and particularly preferably of <850 g/mol.

In one embodiment of the process according to the invention the Brønsted-acidic catalyst (A) has a pKa value of not more than 1, preferably of not more than 0.

In one embodiment of the process according to the invention the Brønsted-acidic catalyst is one or more compounds and is selected from the group consisting of aliphatic fluorinated sulfonic acids, aromatic fluorinated sulfonic acids, trifluoromethanesulfonic acid, perchloric acid, hydrochloric acid, hydrobromic acid, hydriodic acid, fluorosulfonic acid, bis(trifluoromethane)sulfonimide, hexafluoroantimonic acid, pentacyanocyclopentadiene, picric acid, sulfuric acid, nitric acid, trifluoroacetic acid, methanesulfonic acid, paratoluenesulfonic acid, aromatic sulfonic acids and aliphatic sulfonic acids, preferably from trifluoromethanesulfonic acid, perchloric acid, hydrochloric acid, hydrobromic acid, hydriodic acid, fluorosulfonic acid, bis(trifluoromethane)sulfonimide, hexafluoroantimonic acid, pentacyanocyclopentadiene, picric acid, sulfuric acid, nitric acid, trifluoroacetic acid, methanesulfonic acid, paratoluenesulfonic acid, methanesulfonic acid and paratoluenesulfonic acid, particularly preferably from trifluoromethanesulfonic acid, perchloric acid, hydrochloric acid, hydrobromic acid, hydriodic acid, bis(trifluoromethane)sulfonimide, pentacyanocyclopentadiene, sulfuric acid, nitric acid and trifluoroacetic acid.

In one embodiment of the process according to the invention the Brønsted-acidic catalyst is employed in an amount of 0.001 mol % to 0.5 mol %, preferably of 0.003 to 0.4 mol % and particularly preferably of 0.005 to 0.3 mol % based on the amount of lactone.

In one embodiment of the process according to the invention in step ii) the catalyst (B) is a tertiary amine (B), a double metal cyanide (DMC) catalyst (B) or a Brønsted-acidic catalyst (B), preferably a double metal cyanide (DMC) catalyst (B).

In one embodiment of the process according to the invention in step ii) the catalyst (B) is a tertiary amine (B), wherein the tertiary amine (B) has an identical definition according to the invention to the tertiary amine (A) from step i).

In an alternative embodiment of the process according to the invention the catalyst (B) is a double metal cyanide (DMC) catalyst (B), wherein the double metal cyanide (DMC) catalyst (B) has an identical definition according to the invention as the double metal cyanide (DMC) catalyst (A).

In one embodiment of the process according to the invention the double metal cyanide (DMC) catalyst (B) comprises an organic complex ligand, wherein the organic complex ligand is one or more compounds and is selected from the group consisting of tert-butanol, 2-methyl-3-buten-2-ol, 2-methyl-3-butyn-2-ol, ethylene glycol mono-tert-butyl ether and 3-methyl-3-oxetanemethanol.

In a further alternative embodiment of the process according to the invention the catalyst (B) is a Brønsted-acidic catalyst (B), wherein the Brønsted-acidic catalyst (B) has an identical definition according to the invention as the Brønsted-acidic catalyst (A).

In one embodiment of the process according to the invention the catalyst (A), preferably the double metal cyanide (DMC) catalyst (A), is identical to the catalyst (B), preferably the double metal cyanide (DMC) catalyst (B), and is added in step i). This is advantageous since there is no need for additional catalyst, preferably double metal cyanide (DMC) catalyst, to be added during the process or for a catalyst used in step i) to be neutralized, inhibited and/or removed. The catalyst may also, but not preferably, be the amine or the Brønsted-acidic catalyst.

In one embodiment of the process according to the invention a solvent may be used in step i) und/or step ii) of the process according to the invention.

In line with the customary definition in the art a solvent is to be understood as meaning one or more compounds which dissolve the lactone, the polyester or the H-functional starter compound and/or the catalyst but without themselves reacting with the lactone, the H-functional starter compound and/or the catalyst.

Suitable solvents are aprotic solvents such as for example toluene, benzene, tetrahydrofuran, dimethyl ether and diethyl ether.

In an alternative embodiment the process according to the invention is performed without addition of a solvent and there is therefore no need for separation thereof in a separate process step after preparation of the polyester.

In the process according to the invention step ii) comprises reacting the polyester from step i) with alkylene oxides in the presence of a catalyst (B).

In the process of the invention, alkylene oxides used may be alkylene oxides having 2-45 carbon atoms. The alkylene oxides having 2-45 carbon atoms are, for example, one or more compounds selected from the group comprising ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, alkylene oxides of C6-C22 α-olefins, such as 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example glycidyl ethers of C1-C22 alkanols and glycidyl esters of C1-C22 alkanecarboxylic acids. Examples of derivatives of glycidol are phenyl glycidyl ether, cresyl glycidyl ether, methyl glycidyl ether, ethyl glycidyl ether and 2-ethylhexyl glycidyl ether. Alkylene oxides used are preferably ethylene oxide and/or propylene oxide, especially propylene oxide. If ethylene oxide and propylene oxide are used in a mixture, the molar EO/PO ratio is 1:99 to 99:1, preferably 5:95 to 50:50. If ethylene oxide and/or propylene oxide are used in a mixture with other unsaturated alkylene oxides, the proportion thereof is 1 to 40 mol %, preferably 2 to 20 mol %.

In an alternative embodiment of the process according to the invention step ii) comprises reacting the polyester from step i) with alkylene oxides and a comonomer in the presence of the catalyst (B), wherein the comonomer is for example carbon dioxide and the catalyst (B) is the double metal cyanide (DMC) catalyst (B), to form a polyester-polyether carbonate polyol block copolymer.

In one embodiment of the process according to the invention the reaction of the H-functional starter substance with the lactone in the presence of the catalyst (A), preferably of the Brønsted-acidic catalyst (A), in step i) is carried out at temperatures of 20° C. to 150° C., preferably of 20° C. to 100° C. Below 20° C. only insignificant, if any, reaction to afford the inventive product takes place and above 150° C. decomposition of the polyester formed and/or unwanted secondary or subsequent reactions take place.

In an alternative embodiment of the process according to the invention the reaction of the H-functional starter substance with the lactone in the presence of the double metal cyanide (DMC) catalyst (A) in step i) is carried out at temperatures of 70° C. to 150° C., preferably of 90° C. to 130° C. Below 70° C. only insignificant, if any, reaction to afford the inventive product takes place and above 150° C. decomposition of the polyester formed and/or unwanted secondary or subsequent reactions take place.

In one embodiment the process according to the invention comprises for step i) the steps of: i-1) initially charging the H-functional starter substance and optionally the catalyst to form a mixture i) i-2) adding the lactone to the mixture i).

In one embodiment of the process according to the invention step i-2) comprises continuous or stepwise addition of the lactone to the H-functional starter substance and reaction to afford the polyester (semi-batch mode).

In the process according to the invention continuous addition of the lactone is to be understood as meaning a volume flow of the lactone of >0 mL/min, wherein the volume flow may be constant or may vary during this step (continuous lactone addition).

In an alternative embodiment of the process according to the invention step i-2) comprises stepwise addition of the lactone to the mixture i) and subsequent reaction to afford the polyester (stepwise lactone addition).

In the process according to the invention stepwise addition of the lactone is to be understood as meaning at least the addition of the entire lactone amount in two or more discrete portions of the lactone, wherein the volume flow of the lactone between the two or more discrete portions is 0 mL/min and wherein the volume flow of the lactone during a discrete portion may be constant or may vary but is >0 mL/min.

In an alternative embodiment step i) of the process according to the invention comprises the steps of:

(i-a) initially charging the H-functional starter substance, the lactone and optionally the catalyst to form a mixture (a)

(i-b) reacting the mixture (a) to afford the polyester, thus corresponding to a batchwise process mode.

In a further alternative embodiment step i) of the process according to the invention comprises the steps of:

i-1) initially charging the catalyst

i-2) adding the lactone and the H-functional starter substance to the catalyst.

The lactone and the H-functional starter substance may be premixed or the lactone and the H-functional starter substance are added to the reactor via separate feeds. This corresponds to a CAOS (Continuous Addition of Starter) mode.

In a further, alternative embodiment step i) comprises continuously mixing the H-functional starter substance, the lactone and the catalyst and reacting the mixture while continuously discharging the polyester product, wherein the reaction is performed for example in a tubular reactor or a continuous stirred tank reactor, thus corresponding to a fully continuous production process for step i) of the inventive process for the polyester.

In one embodiment the process according to the invention comprises for step ii) the steps of:

ii-1) initially charging the polyester from step i) optionally containing the catalyst (A) and/or (B)

ii-2) adding the alkylene oxide and optionally a comonomer.

In a preferred embodiment of the process according to the invention step ii-2) comprises continuous or stepwise addition of the alkylene oxide to the polyester and reaction to afford the polyester-polyether polyol block copolymer (semi-batch mode).

In the process according to the invention continuous addition of the alkylene oxide in step ii-2) is to be understood as meaning a volume flow of the alkylene oxide of >0 mL/min, wherein the volume flow may be constant or may vary during this step (continuous alkylene addition).

In an alternative embodiment of the process according to the invention step ii-2) comprises stepwise addition of the alkylene oxide to the mixture i) and subsequent reaction to afford the polyester-polyether polyol block copolymer (stepwise alkylene oxide addition).

In the process according to the invention stepwise addition of the alkylene oxide is to be understood as meaning at least the addition of the entire alkylene oxide amount in two or more discrete portions of the alkylene oxide, wherein the volume flow of the alkylene oxide between the two or more discrete portions is 0 mL/min and wherein the volume flow of the alkylene oxide during a discrete portion may be constant or may vary but is >0 mL/min.

In an alternative embodiment step ii) of the process according to the invention comprises the steps of:

(ii-a) initially charging the polyester from step i) and the alkylene oxide optionally containing the catalyst (A) and/or (B) to form a mixture (ii-a)

(ii-b) reacting the mixture (ii-a) to afford the polyester-polyether polyol block copolymer, thus corresponding to a batchwise process mode of step ii).

In a further alternative embodiment step ii) of the process according to the invention comprises the steps of:
ii-1) optionally initially charging the catalyst (B) in a reactor

ii-2) adding the polyester from step i) optionally containing the catalyst (A) to the reactor optionally containing catalyst (B) to the catalyst.

The alkylene oxide and the polyester may be premixed or the alkylene oxide and the polyester may be added to the reactor via separate feeds. This corresponds to a CAOS (Continuous Addition of Starter) mode of step ii).

In a further, alternative embodiment step ii) comprises continuously mixing the polyester optionally containing the catalyst (A), the alkylene oxide and the optionally the catalyst (B) and reacting the mixture while continuously discharging the polyester-polyether polyol block copolymer product, wherein the reaction is performed for example in a tubular reactor or a continuous stirred tank reactor, thus corresponding to a fully continuous production process for step ii) of the inventive process for the polyester.

In one embodiment of the process according to the invention step ii) is performed in an inert gas atmosphere such as for example nitrogen or argon or in a carbon dioxide atmosphere, wherein in the carbon dioxide atmosphere polyester-polyether carbonate polyol block copolymers are formed by incorporation of the CO2.

In one embodiment of the process according to the invention step i) and ii) are performed in the same reactor or in different reactors, preferably in the same reactor.

Any reactors known to those skilled in the art having suitable mixing apparatuses are suitable for said performing.

The present invention further provides polyesters obtainable by the process according to the invention.

The present invention further provides polyester-polyether polyol block copolymers obtainable by the process according to the invention.

In one embodiment the polyester-polyether polyol block copolymer according to the invention has a number-average molecular weight of 70 g/mol to 15 000 g/mol, preferably of 100 g/mol to 10 000 g/mol and particularly preferably of 100 g/mol to 5000 g/mol, wherein the number-average molecular weight is determined by gel permeation chromatography (GPC) as disclosed in the experimental section.

The present invention further provides polyurethane polymers obtainable by reaction of a polyisocyanate with a polyester-polyether polyol block copolymer obtainable by the process according to the invention and to a process for preparing polyurethane polymers.

The polyisocyanate may be an aliphatic or aromatic polyisocyanate. Examples include 1,4-butylene diisocyanate, 1,5-pentane diisocyanate, 1,6-hexamethylene diisocyanate (HDI) and dimers, trimers, pentamers, heptamers or nonamers or mixtures thereof, isophorone diisocyanate (IPDI), 2,2,4- and/or 2,4,4-trimethylhexamethylene diisocyanate, the isomeric bis(4,4′-isocyanatocyclohexyl)methanes or mixtures thereof with any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), and also alkyl 2,6-diisocyanatohexanoates (lysine diisocyanates) having C1 to C6-alkyl groups.

In addition to the abovementioned polyisocyanates, it is also possible to co-use proportions of modified diisocyanates having a uretdione, isocyanurate, urethane, carbodiimide, uretonimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

In a first embodiment the invention relates to a process for preparing a polyester-polyether polyol block copolymer comprising the steps of:

i) reacting an H-functional starter substance with lactone to afford a polyester

ii) reacting the polyester from step i) with alkylene oxides in the presence of a catalyst (B);

wherein the lactone is a 4-membered lactone.

In a second embodiment the invention relates to a process according to the first embodiment, wherein step i) is performed in the presence of the catalyst (A).

In a third embodiment the invention relates to a process according to the second embodiment, wherein the catalyst (A) is an amine (A), a double metal cyanide (DMC) catalyst (A) or a Brønsted-acidic catalyst (A), preferably a double metal cyanide (DMC) catalyst (A).

In a fourth embodiment the invention relates to a process according to the third embodiment, wherein the catalyst (A) is a double metal cyanide (DMC) catalyst (A) and the double metal cyanide (DMC) catalyst (A) comprises an organic complex ligand, wherein the organic complex ligand is one or more compounds and is selected from the group consisting of tert-butanol, 2-methyl-3-buten-2-ol, 2-methyl-3-butyn-2-ol, ethylene glycol mono-tert-butyl ether and 3-methyl-3-oxetanemethanol.

In a fifth embodiment the invention relates to a process according to any of the first to fourth embodiments, wherein the H-functional starter substance comprises an H-functional starter compound having one or more free carboxyl groups and/or functional starter compound having one or more free hydroxyl groups, preferably an H-functional starter compound having one or more free carboxyl groups.

In a sixth embodiment the invention relates to a process according to the fifth embodiment, wherein the H-functional starter substance is an H-functional starter compound having one or more free carboxyl groups and the H-functional starter compound having one or more free carboxyl groups is one or more compounds and is selected from the group consisting of the H-functional starter substance having one or more free carboxyl groups one or more compounds and is selected from the group consisting of monobasic carboxylic acids, polybasic carboxylic acids, carboxyl-terminated polyesters, carboxyl-terminated polycarbonates, carboxyl-terminated polyether carbonates, carboxyl-terminated polyether ester carbonate polyols and carboxyl-terminated polyethers.

In a seventh embodiment the invention relates to a process according to the sixth embodiment, wherein the H-functional starter compound having one or more free carboxyl groups is one or more compounds and is selected from the group consisting of methanoic acid, ethanoic acid, propanoic acid, butanoic acid, pentanoic acid, hexanoic acid, heptanoic acid, octanoic acid, decanoic acid, dodecanoic acid, tetradecanoic acid, hexadecanoic acid, octadecanoic acid, lactic acid, fluoroacetic acid, chloroacetic acid, bromoacetic acid, iodoacetic acid, difluoroacetic acid, trifluoroacetic acid, dichloroacetic acid, trichloroacetic acid, oleic acid, salicylic acid, benzoic acid, oxalic acid, malonic acid, succinic acid, glutaric acid, adipic acid, pimelic acid, suberic acid, azelaic acid, sebacic acid, citric acid, trimesic acid, fumaric acid, maleic acid, 1,10-decanedicarboxylic acid, 1,12-dodecanedicarboxylic acid, phthalic acid, isophthalic acid, terephthalic acid, pyromellitic acid and trimellitic acid, acrylic acid and methacrylic acid.

In an eighth embodiment the invention relates to a process according to any of the first to seventh embodiments, wherein the 4-membered lactone are one or more compounds selected from the group consisting of propiolactone, β-butyrolactone, β-isovalerolactone, β-caprolactone, β-isocaprolactone, β-methyl-β-valerolactone, diketene, preferably propiolactone and β-butyrolactone.

In a ninth embodiment the invention relates to a process according to any of the first to eighth embodiments, wherein the catalyst (B) is a tertiary amine (B), a double metal cyanide (DMC) catalyst (B) or a Brønsted-acidic catalyst (B), preferably a double metal cyanide (DMC) catalyst (B).

In a tenth embodiment the invention relates to a process according to any of the first to ninth embodiments, wherein the alkylene oxide is ethylene oxide and/or propylene oxide.

In an eleventh embodiment the invention relates to a process according to any of the third to seventh embodiments, wherein the double metal cyanide (DMC) catalyst (A) is identical to the double metal cyanide (DMC) catalyst (B) and is added in step i).

In a twelfth embodiment the invention relates to a process according to any of the first to eleventh embodiments, wherein the process is performed without addition of a solvent.

In a thirteenth embodiment the invention relates to a polyester obtainable by a process according to any of the first to ninth embodiments.

In a fourteenth embodiment the invention relates to a polyester-polyether polyol block copolymer obtainable by a process according to any of the first to twelfth embodiments.

In a fifteenth embodiment the invention relates to a polyurethane polymer obtainable by reaction of a polyisocyanate with a polyester-polyether polyol block copolymer according to the fourteenth embodiment.

### EXAMPLES

The present invention is elucidated in detail by the figures and examples which follow, but without being limited thereto.

Starting Materials Used

Cyclic Lactones

β-Propiolactone (purity 98.5%, Ferak Berlin GmbH)

Epoxides

Propylene oxide (99.5%, Sigma Aldrich)

H-Functional Starter Substance PPG-1000 (propylene oxide-based polyether having an average molecular weight of 1000 g/mol) Adipic acid (Sigma-Aldrich, BioXtra, 99.5% (HPLC)) 15

Catalysts

All examples employed a DMC catalyst produced according to example 6 in WO 01/80994 A1.

Solvent

THF (Fisher Scientific GPC Grade)

Description of the Methods:

¹H NMR

The conversion of the monomer was determined by ¹H NMR (Bruker DPX 400, 400 MHz; pulse program zg30, relaxation time D 1: 10 s, 64 scans). Each sample was dissolved in deuterated chloroform. The relevant resonances in the ¹H NMR (relative to TMS=0 ppm) and the assignment of the area integrals (A) are as follows:
poly(hydroxypropionate) (=polypropiolactone) with resonances at 4.38 (2H) and 2.66 (2H)
β-propiolactone with resonances at 4.28 (2H) and 3.54 (2H)
poly(propylene oxide) with resonances at 3.60-3.20 (3H) and 1.12 (3H)
propylene oxide with resonances at 2.98 (1H), 2.75 (1H), 2.43 (1H) and 1.32 (3H)

The conversion of the respective monomer is determined as an integral of a suitable polymer signal divided by the sum of a suitable polymer signal and monomer signal. All signals are referenced to 1H.

Thermogravimetric Analysis

The samples were analyzed according to DIN EN ISO/IEC 17025 using a TGA/SDTA851e instrument from Mettler-Toledo GmbH. Measurement was carried out between 30° C. to 600° C. at a heating rate of 10° C./min in air (50.0 mL/min).

### Example 1: Preparation of a Polyester-Polyether Polyol Block Copolymer (Having a PET-PES-PET Block Copolymer Structure) by Block Copolymerization of Propiolactone and Propylene Oxide Via DMC Catalysis

THF (50.0 g), DMC catalyst (3000 ppm based on the total mass of starter and β-lactone) and adipic acid (1.46 g, 10.0 mmol, 1.00 eq.) are initially charged into a 300 mL steel reactor. The reactor is purged with N₂. β-Propiolactone (18.5 g, 257 mmol, 25.7 eq.) is then continuously fed into the reactor over 120 min at 130° C. The mixture is stirred for a further 120 min at 130° C. Propylene oxide (10.0 g, 172 mmol, 17.2 eq.) is then continuously fed into the reactor over 60 minutes. The mixture is stirred for a further 180 min at 130° C. The conversions are determined from the reaction solution by ¹H NMR. Volatile components are subsequently removed under vacuum. The copolymer is investigated for thermal stability by TGA analysis.

### Example 2: Preparation of a Polyester-Polyether Polyol Block Copolymer (Having a PET-PES-PET Block Copolymer Structure) by Block Copolymerization of Propiolactone and Propylene Oxide Via DMC Catalysis

THF (50.0 g), DMC catalyst (3000 ppm based on the total mass of starter and β-lactone) and adipic acid (2.92 g, 20.0 mmol, 1.00 eq.) are initially charged into a 300 mL steel reactor. The reactor is purged with N₂. β-Propiolactone (17.1 g, 237 mmol, 11.9 eq.) is then continuously fed into the reactor over 120 min at 130° C. The mixture is stirred for a further 120 min at 130° C. Propylene oxide (40.0 g, 689 mmol, 34.5 eq.) is then continuously fed into the reactor over 90 minutes. The mixture is stirred for a further 180 min at 130° C. The conversions are determined from the reaction solution by ¹H NMR. Volatile components are subsequently removed under vacuum. The copolymer is investigated for thermal stability by TGA analysis.

### Example 3 (Comparative): Preparation of a Polyester-Polyether Polyol Block Copolymer (Having a PES-PET-PES Block Copolymer Structure) by Polymerization of Propiolactone onto a Polymeric Propylene Oxide-Based Polyether by DMC Catalysis

THF (50.0 g), DMC catalyst (3000 ppm based on the total mass of starter and β-lactone) and PPG-1000 (10.0 g, 10.0 mmol, 1.00 eq.) are initially charged into a 300 mL steel reactor. The reactor is purged with N₂. β-Propiolactone (20.0 g, 276 mmol, 27.6 eq.) is then continuously fed into the reactor over 120 min at 130° C. The mixture is stirred for a further 120 min at 130° C. The conversions are determined from the reaction solution by ¹H NMR. Volatile components are subsequently removed under vacuum. The copolymer is investigated for thermal stability by TGA analysis.

TABLE 1
Polyether ester block copolymers from β-lactones and propylene oxide via DMC catalysis

| | | | | H-funct. | | | | | | | |
|---|---|---|---|---|---|---|---|---|---|---|---|
| | Block | | | Starter | | x(cat) | MW_{target} | m(PET)/ | MW [g/mol] | X(lactone) | X(PO) |
| No. | structure^{[a]} | Lactone | Epoxide | substance | Solvent | [ppm] | [g/mol] | m(PES) | Outer block | [%] | [%] |
| Ex. 1 | PET-PES-PET | bPL | PO | Adipic acid | THF | 3000 | 3000 | 0.5 | PET: 500 | 100 | 100 |
| Ex. 2 | PET-PES-PET | bPL | PO | Adipic acid | THF | 3000 | 3000 | 2 | PET: 1000 | 100 | 100 |
| Ex. 3 | PES-PET-PES | bPL | — | PPG-1000 | THF | 3000 | 3000 | 0.5 | PES: 1000 | 100 | 100 |
| (comp.) | | | | | | | | | | | |

^{[a]}PES: polyester block (bPL-based), PET: polyether block (PO-based)

TABLE 2
Decomposition temperatures T_{d} of the polyether ester block copolymers
from β-lactones and propylene oxide via DMC catalysis

| | Block | T_{d(1.0%)} | T_{d(5.0%)} |
|---|---|---|---|
| No. | structure^{[a]} | [° C.] ^{[b]} | [° C.] ^{[b]} |
| Ex. 1 | PET-PES-PET | 165 | 245 |
| Ex. 2 | PET-PES-PET | 167 | 234 |
| Ex. 3 (comp.) | PES-PET-PES | 122 | 191 |

^{[a]}PES: polyester block (bPL-based), PET: polyether block (PO-based);
^{[b]} TGA determined temperature at 1% or 5% mass loss

1. A process for producing a polyester-polyether polyol block copolymer, comprising:
i) reacting an H-functional starter substance with lactone to afford a polyester; and
ii) reacting the polyester from step i) with an alkylene oxide in the presence of a catalyst (B);
wherein the lactone comprises a 4-membered lactone.

2. The process as claimed in claim 1, wherein step i) is performed in the presence of a catalyst (A).

3. The process as claimed in claim 2, wherein the catalyst (A) comprises an amine (A), a double metal cyanide (DMC) catalyst (A) or a Brønsted-acidic catalyst (A).

4. The process as claimed in claim 3, wherein the catalyst (A) comprises a double metal cyanide (DMC) catalyst (A) and the double metal cyanide (DMC) catalyst (A) comprises an organic complex ligand, wherein the organic complex ligand is one or more compounds and comprises tert-butanol, 2-methyl-3-buten-2-ol, 2-methyl-3-butyn-2-ol, ethylene glycol mono-tert-butyl ether and 3-methyl-3-oxetanemethanol, or a mixture thereof.

5. The process as claimed in claim 1, wherein the H-functional starter substance comprises an H-functional starter compound having one or more free carboxyl groups and/or functional starter compound having one or more free hydroxyl groups.

6. The process as claimed in claim 5, wherein the H-functional starter substance comprises an H-functional starter compound having one or more free carboxyl groups a monobasic carboxylic acid, a polybasic carboxylic acid, a carboxyl-terminated polyester, a carboxyl-terminated polycarbonate, a carboxyl-terminated polyether carbonate, a carboxyl-terminated polyether ester carbonate polyol, a carboxyl-terminated polyether, or a mixture thereof.

7. The process as claimed in claim 6, wherein the H-functional starter compound having one or more free carboxyl groups comprises methanoic acid, ethanoic acid, propanoic acid, butanoic acid, pentanoic acid, hexanoic acid, heptanoic acid, octanoic acid, decanoic acid, dodecanoic acid, tetradecanoic acid, hexadecanoic acid, octadecanoic acid, lactic acid, fluoroacetic acid, chloroacetic acid, bromoacetic acid, iodoacetic acid, difluoroacetic acid, trifluoroacetic acid, dichloroacetic acid, trichloroacetic acid, oleic acid, salicylic acid, benzoic acid, oxalic acid, malonic acid, succinic acid, glutaric acid, adipic acid, pimelic acid, suberic acid, azelaic acid, sebacic acid, citric acid, trimesic acid, fumaric acid, maleic acid, 1,10-decanedicarboxylic acid, 1,12-dodecanedicarboxylic acid, phthalic acid, isophthalic acid, terephthalic acid, pyromellitic acid and trimellitic acid, acrylic acid, methacrylic acid, or a mixture thereof.

8. The process as claimed in claim 1, wherein the 4-membered lactone comprises propiolactone, β-butyrolactone, β-isovalerolactone, β-caprolactone, β-isocaprolactone, β-methyl-β-valerolactone, diketene, preferably propiolactone, β-butyrolactone, or a mixture thereof.

9. The process as claimed in any of claim 1, wherein the catalyst (B) comprises a tertiary amine (B), a double metal cyanide (DMC) catalyst (B) or a Brønsted-acidic catalyst (B).

10. The process as claimed in claim 1, wherein the alkylene oxide comprises ethylene oxide and/or propylene oxide.

11. The process as claimed in claim 3, wherein the double metal cyanide (DMC) catalyst (A) is identical to the double metal cyanide (DMC) catalyst (B) and is added in step i).

12. The process as claimed in claim 1, wherein the process is performed without addition of a solvent.

13. A polyester obtained by the process as claimed in claim 1.

14. A polyester-polyether polyol block copolymer obtained by the process as claimed in claim 1.

15. A polyurethane polymer obtained by reaction of a polyisocyanate with the polyester-polyether polyol block copolymer as claimed in claim 14.
